(19) United States
(12) Patent Application Publication
(10) Pub. No.: US 2003/0161585 A1
(43) Pub. Date: Aug. 28, 2003

(54) Fiber optics ferrule calibrating instrument and fiber optics ferrule precision improvement apparatus

(75) Inventors: Chao-Nien Tung, Hsinchu City (TW); Yuan-Ta Sui, Panchiao City (TW); Tien-Fa Pai, Hsin-Chuang City (TW); Chun-Shu Hou, Chiayi City (TW)

Correspondence Address: BACON & THOMAS, PLLC, 625 SLATERS LANE, FOURTH FLOOR, ALEXANDRIA, VA, 22314

(73) Assignee: New Century Technology Co., Hsinchu City (TW)

(21) Appl. No.: 10/083,349

(22) Filed: Feb. 27, 2002

(51) Int. Cl. G02B 6/36; G02B 6/00

(52) U.S. Cl. 385/78; 385/134

(57) ABSTRACT

A fiber optics ferrule precision improvement apparatus controlled to insert a ceramic fiber optics ferrule calibrating axle into the inner diameter or onto the outer diameter of a fiber optics ferrule, so as to expand the inner diameter or compress the outer diameter of the fiber optics ferrule, calibrating the inner diameter or outer diameter of the fiber optics ferrule to the dimension tolerance and roundness approximately equal to the ceramic fiber optics ferrule calibrating axle, and keeping the tolerance of the fiber optics ferrule within 1˜3 μm. The fabrication of the ceramic fiber optics calibrating axle includes the steps of ceramic powder pre-treatment process, ceramic powder activation process, blank axle body formation process, sintering process, and high-precision grinding process.

### BACKGROUND OF THE INVENTION

1. Field of the Invention

The present invention relates to a fiber optics ferrule calibrating instrument and fiber optics ferrule precision improvement apparatus. The fabrication of the ceramic fiber optics calibrating axle includes the steps of ceramic powder pre-treatment process, ceramic powder activation process, blank axle body formation process, sintering process, and high-precision grinding process.

2. Description of the Related Art

Following fast development of communication technology, the establishment of telephone and network communication facilities shortens the distance between people. The transmission of signals between communication facilities may be made through either of two ways, i.e., the wired transmission method and the wireless transmission method. The wired transmission method is stable and effective. The wireless transmission method is not absolutely free from the affect of weather and geology. The wired transmission method uses a cable as a medium to transmit electronic or optical signal. The transmission of optical signal can be as fast as N¹¹ bit-per-second. The cable for the transmission of optical signal is fiber optics. Fiber optics provides the advantages of wide bandwidth, light in weight, high accuracy of signal transmission, high stability of signal transmission, and EMI (electromagnetic interference) prevention. The units at the ends of fiber optics are the ph transmitter module and the photo receiver module. Photo signal transmitted from the photo transmitter module to the photo receiver module through the fiber optics. The photo transmitter module and the photo receiver module commonly comprise a casing, and a light emitting element or light receiving element. The casing comprises a fiber optics ferrule adapted to receive one end of a singlemode or multimode fiber optics. The light emitting element of the photo transmitter module can be a light emitting diode or laser diode mounted in a receiving chamber in a base at the bottom side of the casing. The photo receiving element of the photo receiver module is a photo diode. The tolerance of the inner diameter of the fiber optics ferrule is critical, i.e., within 0.5˜1.0 μm. Conventionally, a metal fiber optics ferrule calibrating axle is used to calibrate the inner diameter and concentricity of the nickel-plated fiber optics ferrule. A metal fiber optics ferrule calibrating axle is a rod member made of hard metal, for example, stainless steel or carbon steel. However, the use of a metal fiber optics ferrule calibrating axle may damage the nickel coating in the inner diameter of the nickel-plated fiber optics ferrule. Furthermore, the investment of a new fiber optics ferrule calibrating instrument is quite expensive.

### SUMMARY OF THE INVENTION

The present invention has been accomplished under the circumstances in view. It is one object of the present invention to provide an automatic equipment, which uses a high-precision ceramic fiber optics ferrule calibrating axle to calibrate the true roundness and dimension precision of fiber optics ferrules efficiently. It is another object of the present invention to provide a fiber optics ferrule calibrating instrument, which automatically efficiently calibrates the dimensional tolerance and true roundness of the inner diameter of fiber optics ferrules. According to one aspect of the present invention, the fiber optics ferrule calibrating instrument is controlled to insert a ceramic fiber optics ferrule calibrating axle into the inner diameter or onto the outer diameter of a fiber optics ferrule, so as to expand the inner diameter or compress the outer diameter of the fiber optics ferrule, calibrating the inner diameter or outer diameter of the fiber optics ferrule to the dimension tolerance and roundness approximately equal to the ceramic fiber optics ferrule calibrating axle, and keeping the tolerance of the fiber optics ferrule within 1˜3 μm. According to another aspect of the present invention, the fabrication of the ceramic fiber optics calibrating axle includes the steps of ceramic powder pre-treatment process, ceramic powder activation process, blank axle body formation process, sintering process, and high-precision grinding process.

### BRIEF DESCRIPTION OF THE DRAWINGS

FIG. 1 is a ceramic fiber optics ferrule calibration axle manufacturing flow according to the present invention.

FIG. 2 is a block diagram showing the architecture of a fiber optics ferrule calibrating instrument according to the present invention.

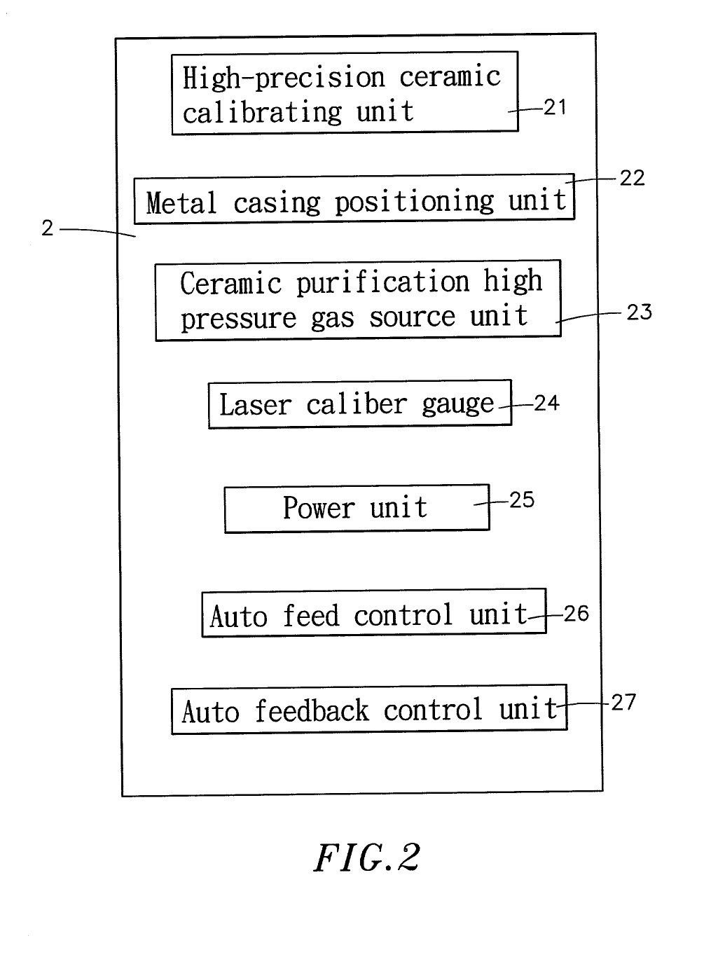

FIG. 3 is an elevational view of the fiber optics ferrule calibrating instrument according to the present invention.

FIG. 3A is an enlarged view of a part of FIG. 3.

FIG. 4 is a sectional view of a fiber optics ferrule and a ceramic fiber optics ferrule calibration axle according to the present invention.

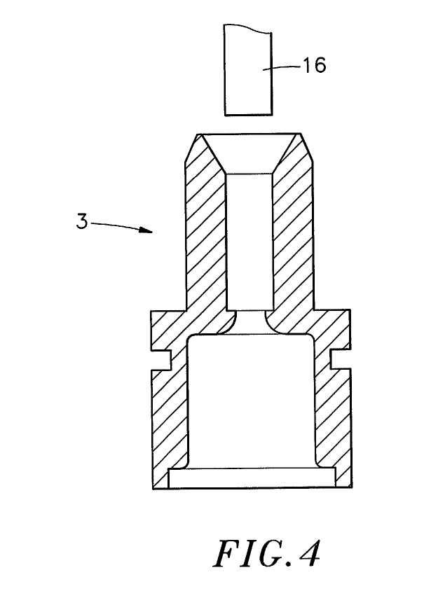

FIG. 5 is a comparison table showing the calibration results obtained from a ceramic fiber optics ferrule calibration axle of the present invention and a metal fiber optics ferrule calibration axle of the prior art design.

### DETAILED DESCRIPTION OF THE PREFERRED EMBODIMENT

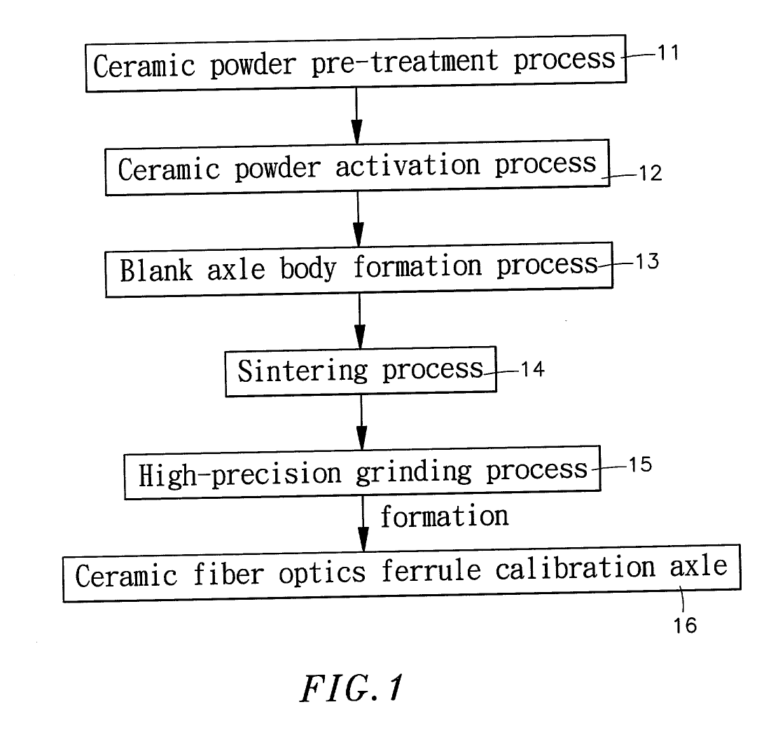

Referring to FIG. 1, the method of fabricating a ceramic fiber optics ferrule calibration axle 16 for use in a fiber optics ferrule calibrating instrument in accordance with the present invention includes the steps of ceramic powder pre-treatment process 11, ceramic powder activation process 12, blank axle body formation process 13, sintering process 14, and high-precision grinding process 15.

The ceramic powder to be used for making the desired ceramic fiber optics ferrule calibration axle 16 is obtained from oxide compound (for example, Al₂O₃, ZrO₂, . . . ), carbon compound (for example, SiC, TiC, WC, B₄C, . . . ), nitrogen compound (for example, TiN, BN, Si₃N₄, . . . ), boride (for example, TiB₂), diamond powder, or a mixture of a part of these materials. Preferably, the ceramic powder is obtained from ZrO₂. The ceramic powder is than processed through the ceramic powder pre-treatment process 11 and the ceramic powder activation procedure 12, and then molded into a blank axle body through the blank axle body formation procedure 13. The blank axle body formation process 13 may be a die casting process, dry sand molding process, extruding process, injection-molding process, hot press molding process, cold press molding process, etc. According to the present invention, an injection-molding process is employed to mold the prepared ceramic powder into a blank axle body. The blank axle body thus obtained is then sintered into a hard axle of relative density within 40%˜100%. Following the increasing of relative density, the service life and precision of the axle are relatively improved. The hard axle thus obtained is then processed into the desired ceramic fiber optics ferrule calibration axle 16 through the high-precision grinding process 15 (mirror grinding process).

Referring to FIGS. From 2 through 4, the toleration of the ceramic fiber optics ferrule calibration axle 16 obtained subject to the aforesaid ceramic fiber optics ferrule calibration axle fabrication method is approximately equal to the bore of a standard fiber optics ferrule 3 (0.5˜1.0 μm). The ceramic fiber optics ferrule calibration axle 16 thus obtained is than installed in a fiber optics ferrule calibrating instrument 2 for calibrating the precision of a fiber optics ferrule 3.

Referring to FIGS. From 2 through 4 again, the fiber optics ferrule calibrating instrument 2 comprises a high-precision ceramic calibrating unit 21, a metal casing positioning unit 22, a ceramic purification high pressure gas source unit 23, a laser caliber gauge 24, a power unit 25, an auto feed control unit 26, and an auto feedback control unit 27. This design can be performed with one single calibrating axle or multiple calibrating axles, to improve the productivity, shorten the working time, and reduce the cost. The main functions of the major parts of the fiber optics ferrule calibrating instrument 2 are outlined hereinafter.

(A) High-precision ceramic calibrating unit 21:This unit is adapted to automatically load the selected high-precision ceramic fiber optics ferrule calibration axle 16 into position, to set the stroke of the high-precision ceramic fiber optics ferrule calibration axle 16 subject to the predetermined calibrating depth (by means of the control of a computer) after its loading, and to automatically replace the high-precision ceramic fiber optics ferrule calibration axle 16 subject to the detection of the laser caliber gauge 24 when the wear rate of the high-precision ceramic fiber optics ferrule calibration axle 16 surpassed the wear allowance.

(B) Metal casing positioning unit 22: This unit is adapted to fix the metal casing of the fiber optics ferrule 3 to be calibrated in position, enabling the auto feed control unit 26 to automatically move the metal casing of the fiber optics ferrule 3 into the calibrating position.

(C) Ceramic purification high pressure gas source unit 23: This unit is adapted to remove dust or metal chip from the high-precision ceramic fiber optics ferrule calibration axle 16 in use after each calibrating action, eliminating variation of tolerance.

(D) Laser caliber gauge 24: This gauge is adapted to detect the dimensional tolerance of the high-precision ceramic fiber optics ferrule calibration axle 16 in use, and to feedback the detection data to the data file, enabling the high-precision ceramic calibrating unit 21 to automatically replace the high-precision ceramic fiber optics ferrule calibration axle 16 when the wear rate of the high-precision ceramic fiber optics ferrule calibration axle 16 surpassed the wear allowance.

(E) Power unit 25: This unit provides the whole system with the necessary working power.

(F) Auto feed control unit 26: This unit is adapted to automatically move the metal casing of the fiber optics ferrule 3 into the calibrating position for calibration.

(G) Auto feedback control unit 27: This unit is adapted to receive and analyze all system signal data, and to output the accurate operation signal subject to the analyzed result.

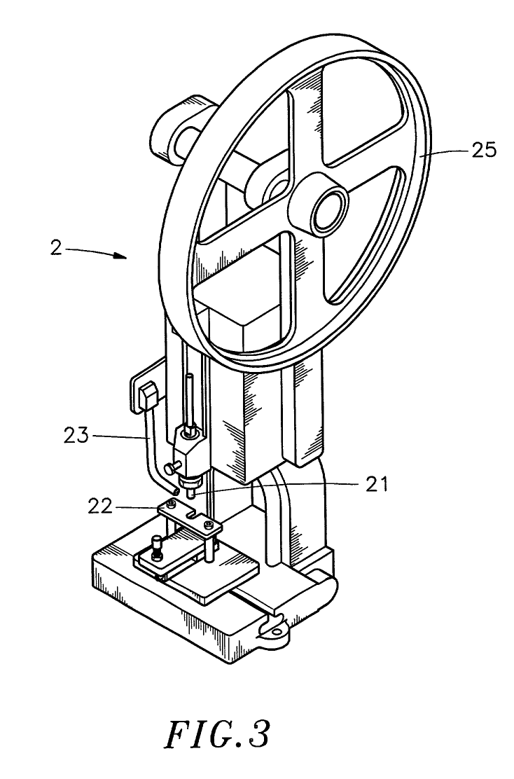

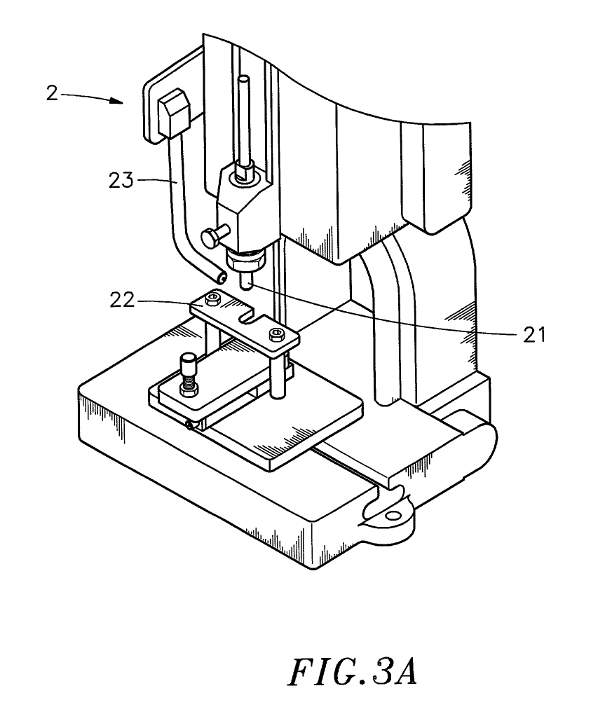

FIGS. 3 and 3A show a miniature form of the manual control fiber optics ferrule calibrating instrument 2. The process of operating the manual control fiber optics ferrule calibrating instrument 2 to calibrate a fiber optics ferrule 3 comprises the steps of:

(1) putting the fiber optics ferrule calibration axle in the high-precision ceramic calibrating unit 21 of the manual control fiber optics ferrule calibrating instrument 2;

(2) setting the down stroke of the high-precision ceramic calibrating unit 21;

(3) putting the fiber optics ferrule 3 to be calibrated in the metal casing positioning unit 22 in the calibrating position;

(4) driving the power unit 25 to move the high-precision ceramic calibrating unit 21, causing the fiber optics ferrule calibration axle to be inserted into the caliber of the fiber optics ferrule 3, and then driving the power unit 25 to move the high-precision ceramic calibrating unit 21, causing the fiber optics ferrule calibration axle to be lifted from the caliber of the fiber optics ferrule 3;

(5) removing the calibrated fiber optics ferrule 3 from the metal casing positioning unit 2, and then putting another calibrated fiber optics ferrule 3 to be calibrated in the metal casing positioning unit 22 for calibration;

(6) operating the ceramic purification high pressure gas source unit 23 (for example, high pressure inert gas source) to remove dust and metal chip from the fiber optics ferrule calibration axle;

(7) repeating the aforesaid steps until the laser caliber gauge 24 detected the wear rate of the fiber optics ferrule calibration axle 16 surpassed the wear allowance.

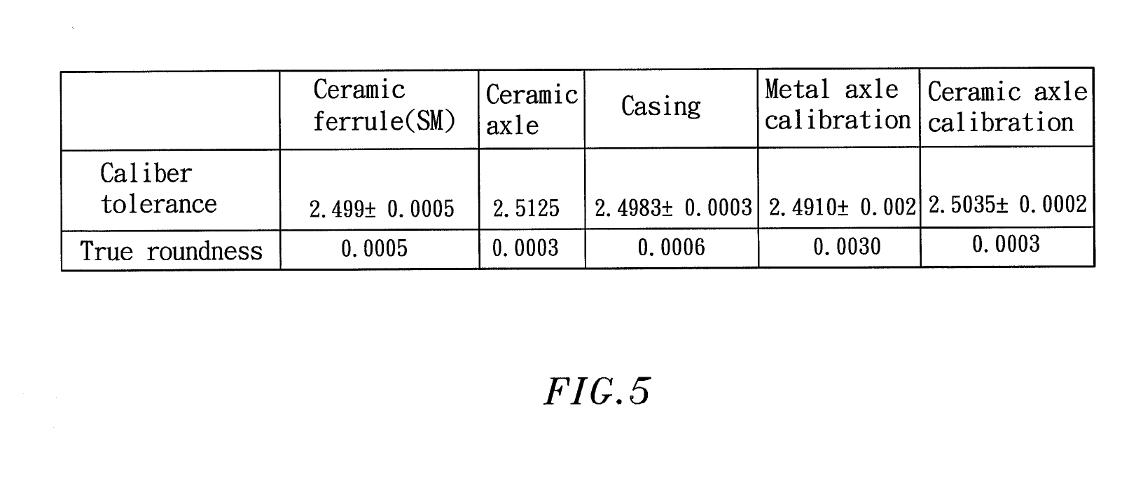

When a high-precision ceramic fiber optics ferrule calibration axle 16 of the present invention and a metal fiber optics ferrule calibration axle of the prior art design respectively used with the aforesaid manual control fiber optics ferrule calibrating instrument 2 to calibrate fiber optics ferrules, the high-precision ceramic fiber optics ferrule calibration axle 16 shows a result better than the metal fiber optics ferrule calibration axle of the prior art design (see FIG. 5). As indicated, the outer diameter of the ceramic fiber optics ferrule calibrating axle 16 is 2.5126 mm; the inner diameter of the fiber optics ferrule 3 is 2.4981 mm; the single side deformation area is 0.00725 mm (about 7 μm); the actual deformation area is 0.00455 mm (about 4.5 μm) when returned after removal of the calibrating axle; the returned rate of zinc material of the nickel-plated layer is 6%˜7%; the outer diameter of the fiber optics ferrule (SM model) 3 is 2.499 mm; the tolerance of the fiber optics ferrule 3 after calibration is 0.0045 mm (4.5 μm). The aforesaid test indicates that effectively controlling the outer diameter of the ceramic fiber optics ferrule calibration axle 16 effectively controls the toleration of the caliber of the fiber optics ferrule 3.

Further, the hardness of ceramic material (over HV1000) is superior to nickel plated zinc cast member (below HV200). Therefore, the service life of the ceramic fiber optics ferrule calibration axle 16 is much longer than a conventional metal fiber optics ferrule calibration axle. According to tests, a conventional metal fiber optics ferrule calibration axle is applicable for 1˜200 tests, and a high-precision ceramic fiber optics ferrule calibration axle 16 of the present invention is applicable for more than 1500 tests. After calibration with a metal fiber optics ferrule calibrating axle, the inner diameter of the calibrated fiber optics ferrule may produce an oxidized layer, or the surface of the inner diameter of the calibrated fiber optics ferrule may be powdered.

According to the aforesaid test, ceramic block material shows a satisfactory result. Thin film material can also achieve the same effect. Metal material of low coefficient of expansion such as Invar (36Ni—Fe), Super Invar (32Ni-0.35Mn-0.3Si—Fe), Kovar (29Ni-17Co—Fe), thermosetting plastics, thermoplastic plastics, ceramic material, glass ceramics (silicate glass, sodium glass, sodium calcium glass, lead glass, borax glass, phosphate glass, aluminate glass), glass ceramics of low coefficient of expansion (for example, LAS), ceramic materials of low hardness (for example, TiO₂, MgO, SiO₂) may be used as base material for the casing for fiber optics ferrule 3, and than coated with a layer of oxide coating, carbon coating, nitrogen coating, diamond coating, or artificial diamond coating to eliminate the drawback of using a metal calibrating axle independently. Further, the ceramic fiber optics ferrule calibrating axle 16 can be made having a bottom recess adapted for calibrating the outer diameter of the fiber optics ferrule 3.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A fiber optics ferrule calibrating instrument comprising:
(a) a high-precision ceramic calibrating unit adapted to automatically load the selected high-precision ceramic fiber optics ferrule calibration axle into position, to set the stroke of the high-precision ceramic fiber optics ferrule calibration axle subject to a predetermined calibrating depth, and to automatically replace the high-precision ceramic fiber optics ferrule calibration axle when the wear rate of the high-precision ceramic fiber optics ferrule calibration axle surpassed the wear allowance;
(b) a metal casing positioning unit adapted to fix the metal casing of the fiber optics ferrule to be calibrated in position, enabling an auto feed control unit to automatically move the metal casing of the fiber optics ferrule into the calibrating position;
(c) a ceramic purification high pressure gas source unit adapted to remove dust or metal chip from the high-precision ceramic fiber optics ferrule calibration axle in use after each calibrating action, eliminating variation of tolerance;
(d) a laser caliber gauge adapted to detect the dimensional tolerance of the high-precision ceramic fiber optics ferrule calibration axle in use, and to feedback the detection data to a data file, enabling the high-precision ceramic calibrating unit to automatically replace the high-precision ceramic fiber optics ferrule calibration axle when the wear rate of the high-precision ceramic fiber optics ferrule calibration axle surpassed the wear allowance;
(e) a power unit, which provides the whole system of the fiber optics ferrule calibrating instrument with the necessary power;
(f) an auto feed control unit adapted to automatically move the metal casing of the fiber optics ferrule into the calibrating position for calibration; and
(g) an auto feedback control unit adapted to receive and analyze all system signal data, and to output the accurate operation signal subject to the analyzed result.

2. The fiber optics ferrule calibrating instrument as claimed in claim 1, which is a multi-axle calibrating instrument adapted to calibrate a plurality of fiber optics ferrules at a time.

3. The fiber optics ferrule calibrating instrument as claimed in claim 1, wherein said high-precision ceramic calibrating unit is adapted to calibrate the inner diameter with a cylindrical high-precision ceramic fiber optics ferrule calibration axle and the outer diameter of a fiber optics ferrule with a high-precision ceramic fiber optics ferrule calibration axle having a calibrating bottom recess.

4. A fiber optics ferrule precision improvement apparatus comprising a ceramic fiber optics ferrule calibrating axle controlled to insert into the inner diameter or sleeve onto the outer diameter of a fiber optics ferrule, so as to expand the inner diameter or compress the outer diameter of the fiber optics ferrule, calibrating the inner diameter or outer diameter of the fiber optics ferrule to the dimension tolerance and roundness approximately equal to the ceramic fiber optics ferrule calibrating axle, and keeping the tolerance of the fiber optics ferrule within 1˜3 μm.

5. The fiber optics ferrule precision improvement apparatus as claimed in claim 4, wherein the material of said high-precision ceramic fiber optics ferrule calibration axle is of block or thin-film material.

6. The fiber optics ferrule precision improvement apparatus as claimed in claim 5, wherein the material of said high-precision ceramic fiber optics ferrule calibration axle contains oxide compound, carbon compound, nitrogen compound, or their mixture.

7. The fiber optics ferrule precision improvement apparatus as claimed in claim 6 wherein said oxide compound includes Al₂O₃, ZrO₂, Cr₂O₃, TiO₂; said carbon compound includes WC, TiC, SiC, B₄C, ZrC, TaC, HfC, Cr₃C₂, NbC; said nitrogen compound includes Si₃N₄, TiN, ZrN, HfN, BN, AIN.

8. The fiber optics ferrule precision improvement apparatus as claimed in claim 5, wherein the material of said high-precision ceramic fiber optics ferrule calibration axle contains boric compound, diamond, or artificial diamond.

9. The fiber optics ferrule precision improvement apparatus as claimed in claim 5, wherein said thin film fabrication includes CVD fabrication and PVD fabrication.

10. The fiber optics ferrule precision improvement apparatus as claimed in claim 4, wherein the fabrication of the ceramic fifer optics calibrating axle includes the steps of ceramic powder pre-treatment process, ceramic powder activation process, blank axle body formation process, sintering process, and high-precision grinding process.

11. The fiber optics ferrule precision improvement apparatus as claimed in claim 10, wherein said blank axle body formation process can be one of the processes including die casting process, dry sand molding process, extruding process, injection-molding process, hot press molding process, and cold press molding process.

12. The fiber optics ferrule precision improvement apparatus as claimed in claim 10, wherein the blank axle body thus obtained from said blank axle body formation process is then sintered into a hard axle of relative density within 40%˜100% through said sintering process.

13. The fiber optics ferrule precision improvement apparatus as claimed in claim 10, wherein the sintered axle thus obtained from said sintering process is then processed into the desired ceramic fiber optics ferrule calibration axle through said high-precision grinding process, which is a mirror grinding process.
